(19) United States
(12) Patent Application Publication
(10) Pub. No.: US 2012/0001821 A1
(43) Pub. Date: Jan. 5, 2012

(54) ANTENNA DEVICE AND WIRELESS COMMUNICATION DEVICE

(75) Inventors: Shinichi NAKANO, Kyoto-fu (JP); Kazunari KAWAHATA, Kyoto-fu (JP); Hiroshi NISHIDA, Kyoto-fu (JP); Kenichi ISHIZUKA, Kyoto-fu (JP)

(73) Assignee: MURATA MANUFACTURING CO., LTD., Kyoto-fu (JP)

(21) Appl. No.: 13/234,962

(22) Filed: Sep. 16, 2011

Related U.S. Application Data
(63) Continuation of application No. PCT/JP2009/068880, filed on Nov. 5, 2009.

(30) Foreign Application Priority Data
Mar. 19, 2009 (JP) 2009-069138

(51) Int. Cl. H01Q 1/50; H01Q 9/04

(52) U.S. Cl. 343/850; 343/700 MS

(57) ABSTRACT

There is provided an antenna device which has a structure using control lines of an integrated circuit as a portion of an emitting electrode so as to prevent electromagnetic coupling between the emitting electrode and the control lines, and thereby prevent the occurrence of unnecessary resonance and deteriorations in antenna characteristics. Also there is provided a wireless communication device of the same. The antenna device includes at least one emitting electrode and an other emitting electrode provided with the control lines. Connection circuits are provided between the control lines and the other emitting electrode to allow an RF signal of the emitting electrode to flow to the control lines such that the other emitting electrode and the control lines function as a single emitting electrode.

### CROSS REFERENCE TO RELATED APPLICATIONS

The present application is a continuation of International Application No. PCT/JP2009/068880 filed Nov. 5, 2009, which claims priority to Japanese Patent Application No. 2009-069138 filed Mar. 19, 2009, the entire contents of each of these applications being incorporated herein by reference in their entirety.

### TECHNICAL FIELD

The present invention relates to an antenna device and a wireless communication device, used for wireless communication.

### BACKGROUND

A small wireless communication device such as a mobile phone or the like has a structure in which the resonant frequency of an antenna device is changed using a switch, so as to have a multiband capability in a state in which the antenna device is kept small in size.

FIG. 28 is a schematic plan view for explaining an antenna device of the related art that utilizes a switch.

As illustrated in FIG. 28, an antenna device 200 includes a switch 130 located in the middle of emitting electrodes 202 and 203 extending from a power feeding unit 110. Accordingly, the switch 130 is changed over, thereby allowing transmission and reception to be performed using two resonant frequencies. Japanese Unexamined Patent Application Publication No. 2006-054639 (Patent Document 1) describes an antenna utilizing a technique similar to the related art, where the antenna structure allows a frequency to be switched.

In addition, as illustrated with a dashed line in FIG. 28, an antenna device also exists in which a reactance circuit 140 is connected in parallel with the switch 130 and the magnitudes of the changes of two resonant frequencies due to the changeover of the switch 130 are controlled. Japanese Unexamined Patent Application Publication No. 2006-165834 (Patent Document 2) describes an antenna utilizing such a technique and structure

### Summary

Embodiments of the present disclosure provide an antenna device and a wireless communication device that can prevent the occurrence of unnecessary resonance and the deterioration of an antenna characteristic, which are due to electromagnetic coupling between an emitting electrode and a control line, by utilizing, as a portion of an emitting electrode, a control line for an integrated circuit.

In one aspect of the disclosure, an embodiment of an antenna device and board includes a first emitting electrode having one end connected to a power feeding unit adapted to supply a high-frequency radio frequency (RF) signal, a second emitting electrode having one end near the other end of the first emitting electrode, the second emitting electrode having at least one leading end that is open, an integrated circuit between an other end of the first emitting electrode and the one end of the second emitting electrode, and plural control lines having respective first ends connected to a control unit adapted to supply a low-frequency control signal for controlling the integrated circuit and having respective second ends connected to the integrated circuit. The antenna device includes a first connection circuit adapted to connect the plural control lines and the first emitting electrode with a high frequency signal that is provided between the first ends of the plural control lines and the one end of the first emitting electrode, and a second connection circuit between the second ends of the plural control lines and the other end of the first emitting electrode, where the second connection circuit is adapted to connect the plural control lines and the first emitting electrode with the high frequency signal. The first and second connection circuits cause the RF signal to flow through the first emitting electrode and the plural control lines.

In a more specific embodiment, an antenna device has a configuration in which the first emitting electrode is provided on a front surface side of the board and the plural control lines are provided in parallel on a rear surface side of the board.

In another more specific embodiment, an antenna device may have a configuration in which the first emitting electrode is provided on a front surface side of the board, and the plural control lines are provided in parallel on the front surface side and a rear surface side of the board.

In yet another more specific embodiment, the first emitting electrode may be divided into two emitting electrodes with one of the two electrodes provided on a front surface side of the board and the other of the two electrodes provided on a rear surface side of the board, and the plural control lines are provided between the two divided electrodes.

In still another more specific embodiment, a first inductor element may be provided between the end of the first emitting electrode and the power feeding unit and a second inductor element may be provided between the end and a ground, thereby forming a matching circuit, and a resistor element or an inductor element may be connected from the other end of the first emitting electrode to a ground terminal of the integrated circuit.

In another more specific embodiment, a dielectric block may be provided on the board, and all of or part of the first and the second emitting electrodes, the integrated circuit, the plural control lines, and the first and the second connection circuits may be provided on the dielectric block.

In yet another more specific embodiment, the integrated circuit may be a switch electrically connecting or disconnecting the first emitting electrode and the second emitting electrode to or from each other, the control unit may be adapted to supply the low frequency control signal to control the switch, and in a state in which the first ends of the plural control lines are connected to a control unit, the plural control lines may be on the board and the second ends thereof are connected to the switch.

In another more specific embodiment, the first connection circuit may include capacitors connected between the first ends of the plural control lines and the one end of the first emitting electrode and are low impedance to the RF signal and high impedance to the control signal. Also, the second connection circuit may include other capacitors that are connected between the other ends of the plural control lines and the other end of the first emitting electrode and are low impedance to the RF signal and high impedance to the control signal.

In another aspect of the disclosure, an antenna device and board includes a first emitting electrode having one end connected to a power feeding unit adapted to supply a high-frequency RF signal, a second emitting electrode having one end near an other end of the first emitting electrode, the second emitting electrode having at least one leading end that is open, an integrated circuit between an other end of the first emitting electrode and the one end of the second emitting electrode, plural control lines having respective first ends connected to a control unit adapted to supply a low-frequency control signal for controlling the integrated circuit and having respective second ends connected to the integrated circuit, and a third emitting electrode having one end connected to a ground through a reactance element. The antenna device includes a first connection circuit between the first ends of the plural control lines and the one end of the third emitting electrode, where the first connection circuit is adapted to connect the plural control lines and the third emitting electrode to a high frequency signal, and a second connection circuit between the second ends of the plural control lines and an other end of the third emitting electrode, where the second connection circuit is adapted to connect the plural control lines and the third emitting electrode to a high frequency signal. The plural control lines are roughly parallel and positioned a distance from the first and the second emitting electrodes, and a third emitting electrode is roughly parallel with the plural control lines.

In a more specific embodiment, a third emitting electrode may be positioned a distance from the first and the second emitting electrodes, and may be divided into two emitting electrodes with one of the two electrodes provided on a front surface side of the board and the other of the two electrodes provided on a rear surface side of the board, and the plural control lines may be between the two divided electrodes.

In another more specific embodiment, the first connection circuit may include capacitors connected between the first ends of the plural control lines and the end of the third emitting electrode and are low impedance to the RF signal and high impedance to the control signal. The second connection circuit may include other capacitors connected between the second ends of the plural control lines and the other end of the third emitting electrode and are low impedance to the RF signal and high impedance to the control signal.

In another more specific embodiment, a first choke circuit may be provided between the first ends of the plural control lines and the control unit, where the first choke circuit is adapted to allow the control signal to pass and stop the RF signal, and a second choke circuit may be provided between the second ends of the plural control lines and the integrated circuit, where the second choke circuit is adapted to allow the control signal to pass and stop the RF signal.

In another more specific embodiment, a dielectric block may be provided on the board and all or part of the first to third emitting electrodes, the integrated circuit, the plural control lines, and the first and the second connection circuits may be provided on the dielectric block.

In yet another aspect of the invention, a wireless communication device can include an antenna device as described in any one of above embodiments.

In another more specific embodiment, any of the above embodiments can utilize a flexible printed circuit board as the board.

### BRIEF DESCRIPTION OF DRAWINGS

FIG. 1 is a schematic plan view illustrating an antenna device according to a first exemplary embodiment.

FIG. 2 is a plan view specifically illustrating an electric structure of the antenna device shown in FIG. 1.

FIG. 3 is a plan view for explaining an operation at the time of the transmission or reception of an RF signal.

FIG. 4 is a pattern diagram illustrating a transmission or reception state of the RF signal.

FIG. 5 is a plan view for explaining an operation at the time of the transmission of a control signal.

FIG. 6 is a pattern diagram illustrating a transmission state of the control signal.

FIG. 7 is a diagrammatic view illustrating a multiple resonance state.

FIG. 8 is a schematic plan view illustrating an antenna device that utilizes a single emitting electrode.

FIG. 9 is a schematic plan view illustrating an antenna device that brings fine line patterns together and utilizes a portion of the antenna device as one emitting electrode.

FIG. 10 is a graph showing a result of simulation of a return loss.

FIG. 11 is a graph showing a result of simulation of antenna efficiency.

FIG. 12 is a schematic plan view illustrating an antenna device according to a second exemplary embodiment.

FIG. 13 is a pattern diagram illustrating an electric structure of a switch.

FIG. 14 is a schematic cross-section diagram illustrating a main part of an antenna device according to a third exemplary embodiment.

FIG. 15 is a schematic cross-section diagram illustrating a main part of an antenna device according to a fourth exemplary embodiment.

FIG. 16 is a plan view specifically illustrating an electric structure of an antenna device according to a fifth exemplary embodiment.

FIG. 17 is a schematic plan view illustrating an antenna device according to a sixth exemplary embodiment.

FIG. 18 is a cross-section diagram along an arrowed line A-A in FIG. 17.

FIG. 19 is a cross-section diagram along an arrowed line B-B in FIG. 17.

FIG. 20 is a pattern diagram illustrating a transmission or reception state of an RF signal.

FIG. 21 is a pattern diagram illustrating a transmission state of a control signal.

FIG. 22 is a schematic plan view illustrating an antenna device according to a seventh exemplary embodiment.

FIG. 23 is a plan view specifically illustrating an electric structure of the antenna device.

FIG. 24 is a schematic plan view illustrating an antenna device according to an eighth exemplary embodiment.

FIG. 25 is a cross-section diagram along an arrowed line C-C in FIG. 24.

FIG. 26 is a perspective view illustrating an antenna device according to a ninth exemplary embodiment.

FIG. 27 is a perspective view illustrating an example of a modification to the ninth exemplary embodiment.

FIG. 28 is a schematic plan view for explaining an antenna device of the related art utilizing a switch.

### DETAILED DESCRIPTION

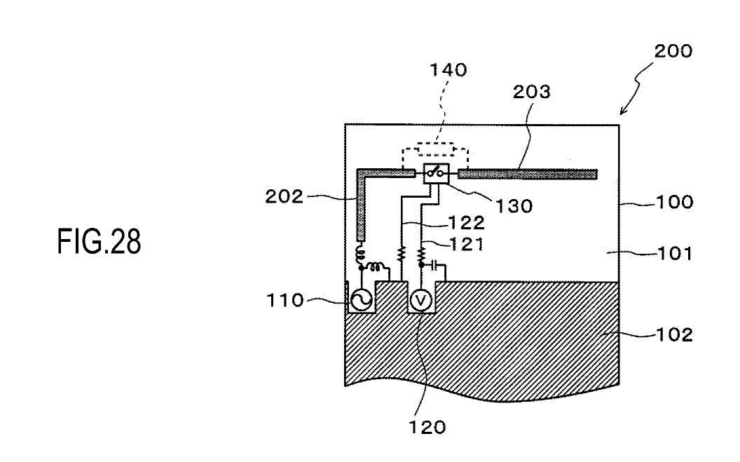

The inventors realized that the antenna device 200 of the related art described above and shown in FIG. 28 has a structure where a control line 121 and a ground line 122, which carry a control signal used for the switching control of the switch 130, are drawn from a control voltage source 120 provided on a non-ground region 101 on a board 100 and then connected to the switch 130, and that as such, electromagnetic coupling occurs between the emitting electrodes 202 and 203 and the control line 121 or the ground line 122 disposed in the antenna device 200. The related art structure, therefore, causes occurrence of unnecessary resonance or the deterioration of an antenna characteristic.

Hereinafter, exemplary embodiments of the present disclosure that can address the shortcomings of the related art will be described with reference to figures.

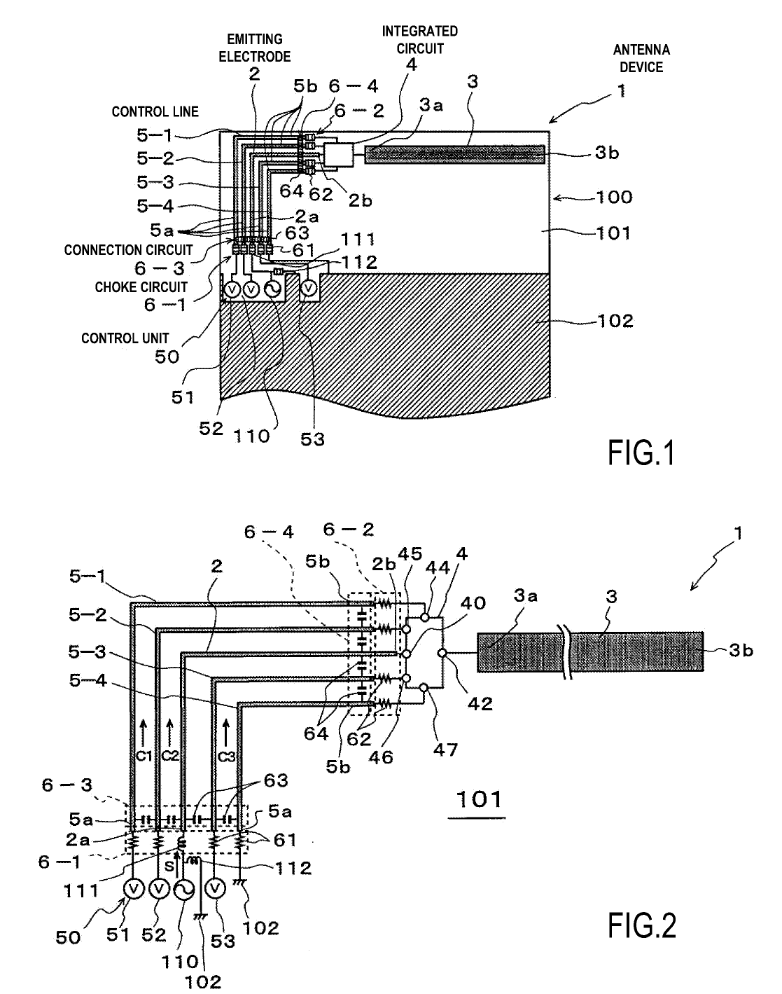

FIG. 1 is a schematic plan view illustrating an antenna device 1 according to a first exemplary embodiment. In addition, FIG. 2 is a plan view specifically illustrating the electric structure of the antenna device 1 show in FIG. 1.

The antenna device 1 according to the presently described embodiment is provided in a wireless communication device such as a mobile phone or the like.

As illustrated in FIG. 1, antenna device 1 is mounted in a non-ground region 101 in a board 100 of a wireless communication device, and includes an emitting electrode 2 functioning as a first emitting electrode, an emitting electrode 3 functioning as a second emitting electrode, an integrated circuit 4, and four control lines 5-1 to 5-4.

As illustrated in FIG. 2, the emitting electrode 2 is a fine line pattern and formed on the non-ground region 101. Specifically, the emitting electrode 2 has an L-shaped structure, and one end 2a thereof is connected, through a matching circuit including inductors 111 and 112, to a power feeding unit 110 capable of supplying an RF signal S having a high frequency. The line width of the emitting electrode 2 is set to roughly the same width as that of each control line 5 (i.e., each of 5-1 to 5-4), and the whole of the emitting electrode 2 and the four control lines 5-1 to 5-4 forms a fine line structure.

In the present embodiment, as the RF signal S, for example, an RF signal can be adopted having a high frequency greater than or equal to 500 MHz.

The emitting electrode 3 is a pattern having a normal width, and is formed in the non-ground region 101 in the same way as the emitting electrode 2. Specifically, the emitting electrode 3 has a linear pattern in which the leading end 3b thereof is open, and one end 3a thereof is provided near the other end 2b of the emitting electrode 2.

In FIG. 1, the integrated circuit 4 is a variable reactance circuit used for changing a reactance value between the emitting electrode 2 and the emitting electrode 3, and is disposed between the other end 2b of the emitting electrode 2 and one end 3a of the emitting electrode 3.

Specifically, as illustrated in FIG. 2, terminals 40 and 42 used for inputting and outputting the RF signal S are provided in the integrated circuit 4, and the other end 2b of the emitting electrode 2 and the end 3a of the emitting electrode 3 are connected to the terminals 40 and 42, respectively. Furthermore, in the integrated circuit 4, input terminals 44 to 46 and a ground terminal 47, used for inputting control signals C1 to C3, are provided.

The four control lines 5-1 to 5-4 illustrated in FIG. 1 has fine line patterns used for sending the control signals C1 to C3 to the integrated circuit 4, and are formed in the non-ground region 101. Each of the control lines 5-1 to 5-4 has an L-shaped structure in the same way as the emitting electrode 2, and runs along the emitting electrode 2.

Specifically, control voltage sources 51 to 53 included in a control unit 50 are provided in a ground region 102 side of the board 100, and the control lines 5-1 to 5-3 receive the control signals C1 to C3, which have low frequencies and are used for controlling the integrated circuit 4, from the control voltage sources 51 to 53.

At the ends of the control unit 50 side and the ends of the integrated circuit 4 side of such control lines 5-1 to 5-4, a choke circuit 6-1 as a first choke circuit and a choke circuit 6-2 as a second choke circuit, and a connection circuit 6-3 as a first connection circuit and a connection circuit 6-4 as a second connection circuit are provided, respectively.

The choke circuits 6-1 and 6-2 are circuits used for allowing the control signals C1 to C3 to pass and stopping the RF signal S, and the connection circuits 6-3 and 6-4 are circuits used for allowing the RF signal S to pass and stopping the control signals C1 to C3.

The choke circuit 6-1 includes four resistor elements 61. Specifically, the resistor elements 61 are provided between the ends 5a of the control lines 5-1 to 5-4 and the control voltage sources 51 to 53 and the ground region 102, respectively. As these four resistor elements 61, resistor elements are adopted that are low impedance to the control signals C1 to C3 and high impedance to the RF signal S.

In addition, the choke circuit 6-2 includes four resistor elements 62, which are provided between the other ends 5b of the control lines 5-1 to 5-4 and the terminals 44 to 47 of the integrated circuit 4, and the four resistor elements 62 are also resistor elements that are low impedance to the control signals C1 to C3 and high impedance to the RF signal S.

On the other hand, the connection circuit 6-3 is a circuit that connects the emitting electrode 2 to the control lines 5-1 to 5-4 with a high frequency and causes the RF signal to flow through the emitting electrode 2 and the control lines 5-1 to 5-4. In addition, the connection circuit 6-3 is provided between the one end 2a of the emitting electrode 2 and the ends 5a of the control lines 5-1 to 5-4 in a state in which the connection circuit 6-3 is provided in a stage previous to the choke circuit 6-1.

Such a connection circuit 6-3 includes four capacitors 63. Specifically, the capacitors 63 are connected between adjacent lines from among the emitting electrode 2 and the control lines 5-1 to 5-4. As these four capacitors 63, capacitors are adopted that are high impedance to the control signals C1 to C3 and low impedance to the RF signal S.

In addition, the connection circuit 6-4 is also a circuit that connects the emitting electrode 2 to the control lines 5-1 to 5-4 with a high frequency and causes the RF signal to flow through the emitting electrode 2 and the control lines 5-1 to 5-4. In addition, the connection circuit 6-4 is provided between the other end 2b of the emitting electrode 2 and the other ends 5b of the control lines 5-1 to 5-4 in a state in which the connection circuit 6-4 is provided in a stage previous to the choke circuit 6-2.

Such a connection circuit 6-4 also includes four capacitors 64 connected between adjacent lines from among the emitting electrode 2 and the control lines 5-1 to 5-4. In addition, the four capacitors 64 are also capacitors that are high impedance to the control signals C1 to C3 and low impedance to the RF signal S.

As described above, the antenna device 1 according to the present embodiment has the fine line structure in which the emitting electrode 2 and the control lines 5-1 to 5-4 are brought together and run parallel to one another, and the choke circuits 6-1 and 6-2 and the connection circuits 6-3 and 6-4 are provided at both ends of the fine line structure. In addition, the lengths of the emitting electrode 2 and the emitting electrode 3 are set to roughly a quarter of a wavelength corresponding to a first resonant frequency f1 based on the reactance values of the emitting electrode 2, the emitting electrode 3, and the integrated circuit 4.

In addition, the control signals C1 to C3 are signals that have low frequencies including a direct voltage. Namely, by adjusting the capacitance values of the capacitors 63 and 64, pulsed digital signals, placed on low frequencies less than or equal to 10 MHz in addition to a direct voltage, may be used as the control signals C1 to C3, for example.

Next, a function and an advantageous effect indicated by the antenna device according to the present embodiment will be described.

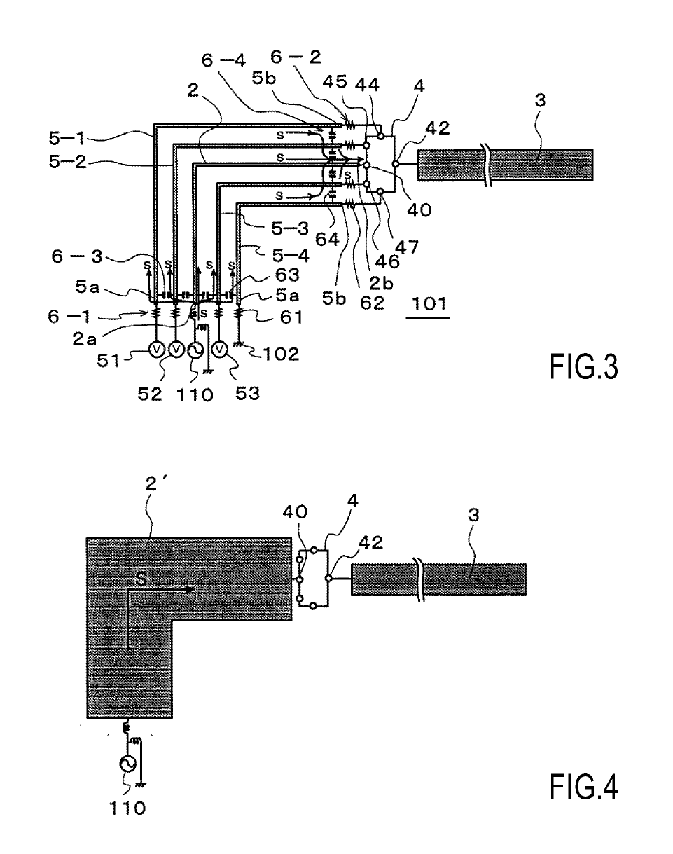

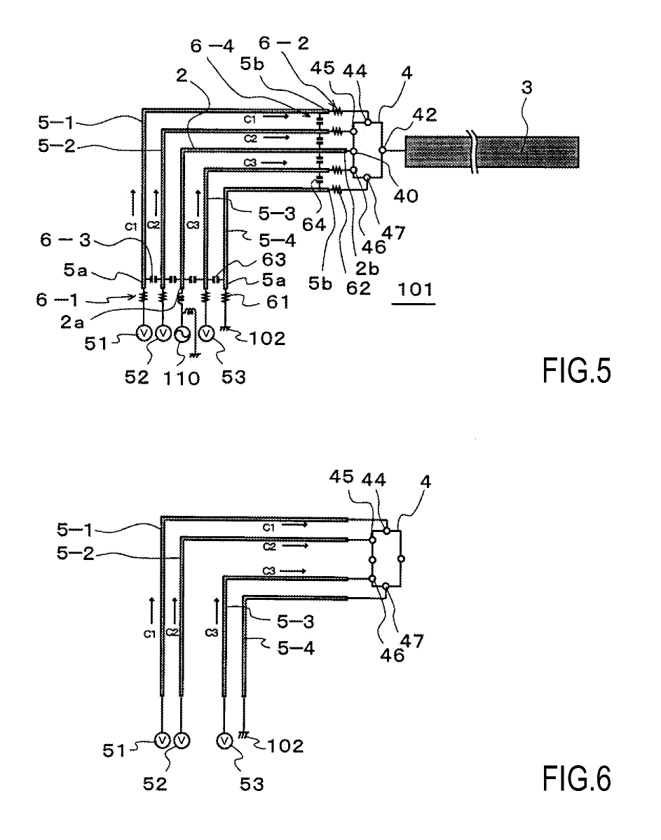

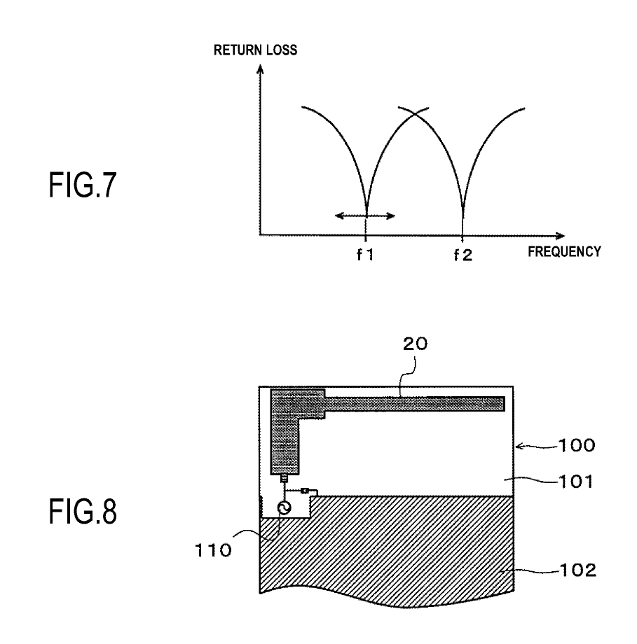

FIG. 3 is a plan view for explaining an operation at the time of the transmission or reception of the RF signal, FIG. 4 is a pattern diagram illustrating a transmission or reception state of the RF signal, FIG. 5 is a plan view for explaining an operation at the time of the transmission of a control signal, FIG. 6 is a pattern diagram illustrating the transmission state of the control signal, and FIG. 7 is a diagrammatic view illustrating a multiple resonance state.

As illustrated in FIG. 3, when the RF signal S is supplied from the power feeding unit 110 to the emitting electrode 2, the RF signal S is input from the end 2a into the emitting electrode 2. At this time, since the emitting electrode 2 and the control lines 5-2 and 5-3, adjacent to one other, are connected through the connection circuit 6-3 with a high frequency, the flow of the RF signal S input into the emitting electrode 2 is split into the control lines 5-1 to 5-4 through these capacitors 63.

Not only does the RF signal input to the control lines 5-1 to 5-4 flow toward the integrated circuit 4 within the control lines 5-1 to 5-4, but also it flows toward the control voltage sources 51 to 53 or the ground region 102 side. However, since, in the present embodiment, the resistor elements 61 in the choke circuit 6-1 are provided between the control voltage sources 51 to 53 and the ground region 102 and the control lines 5-1 to 5-4, the RF signal S is stopped by these resistor elements 61, and does not flow to the control voltage sources 51 to 53 or the ground region 102 side.

Accordingly, the RF signal S only flows toward the integrated circuit 4 within the emitting electrode 2 and the control lines 5-1 to 5-4. In addition, when the RF signal S reaches the other ends 5b of the control lines 5-1 to 5-4, the RF signal S is stopped by the resistor elements 62 in the choke circuit 6-2, and merges into the emitting electrode 2 through the capacitors 64 in the connection circuit 6-4.

When an RF signal is received, the flow of the RF signal S is split into the control lines 5-1 to 5-4 by the capacitors 64 in the connection circuit 6-4, and merges into the emitting electrode 2 through the capacitors 63 in the connection circuit 6-3.

In this way, since the connection circuits 6-3 and 6-4 connect the emitting electrode 2 to the control lines 5-1 to 5-4 with a high frequency at the time of the transmission or reception of the RF signal S, not only does the RF signal S flow through the emitting electrode 2, but it also flows through the control lines 5-1 to 5-4. Namely, at the time of the transmission or reception of the RF signal S, the control lines 5-1 to 5-4 and the emitting electrode 2 are put into a state in which the control lines 5-1 to 5-4 and the emitting electrode 2 are connected in parallel, and the emitting electrode 2 and the control lines 5-1 to 5-4 have the same potential. As a result, as illustrated in FIG. 4, the emitting electrode 2 and the control lines 5-1 to 5-4 turn out to function as a single emitting electrode 2′.

Accordingly, the RF signal S turns out to propagate between the emitting electrodes 2 and 3 through the integrated circuit 4, and as illustrated in FIG. 7, it is possible to transmit and receive the RF signal S using the first resonant frequency f1 corresponding to the reactance values of the emitting electrode 2, the emitting electrode 3, and the integrated circuit 4.

In addition, as illustrated in FIG. 5, the control signals C1 to C3 are transmitted from the control unit 50 to the integrated circuit 4 through the control lines 5-1 to 5-4, and the reactance value of the integrated circuit 4 is changed, thereby allowing the first resonant frequency f1 to be changed as illustrated by an arrow in FIG. 7.

In such a case, when, as illustrated in FIG. 5, the control signals C1 to C3 are supplied from the control unit 50, the control signals C1 to C3 reach the ends 5a of the control lines 5-1 to 5-3 through the resistor elements 61 in the choke circuit 6-1, the resistor elements 61 being in low impedance states, because the control signals C1 to C3 are signals having low frequencies.

At this time, since the control signals C1 to C3 are signals having low frequencies, the control signals C1 to C3 are stopped by the capacitors 63 in high impedance states, and do not flow into the emitting electrode 2 or the control lines 5-1 to 5-4.

These control signals C1 to C3 flow toward the integrated circuit 4 side through the control lines 5-1 to 5-4, and are input to the input terminals 44 to 46 in the integrated circuit 4 from the other ends 5b through the resistor elements 62 in the choke circuit 6-2, the resistor elements 62 being in low impedance states. At this time, in the same way as described above, the control signals C1 to C3 having low frequencies are stopped by the capacitors 64 in high impedance states.

Accordingly, as illustrated in FIG. 6, when the control signals C1 to C3 are transmitted, only the control lines 5-1 to 5-4 function. Therefore, each control signal C1, C2, and C3 only flows into the corresponding control line 5-1, 5-2, and 5-3, and is certainly input to each input terminal 44, 45, and 46 in the integrated circuit 4 without flowing into the emitting electrode 2 or the neighboring control lines 5-1 to 5-4, thereby causing the reactance value of the integrated circuit 4 to be changed.

In addition, by transmitting to the integrated circuit 4 the control signals C1 to C3 causing the reactance value of the integrated circuit 4 to be roughly infinite, the emitting electrode 2 and the emitting electrode 3 can be electrically disconnected from each other.

Accordingly, as illustrated in FIG. 7, it is possible to transmit and receive the RF signal S using a second resonant frequency f2 that corresponds to the single emitting electrode 2′ (refer to FIG. 4) including the emitting electrode 2 and the control lines 5-1 to 5-4.

In this way, according to the antenna device 1 of the present embodiment, it is possible to perform transmission and reception using a multiple resonance based on the first resonant frequency f1 and the second resonant frequency f2, and in addition, by changing the first resonant frequency f1, it is possible to promote the widening of a bandwidth.

As described above, in the present embodiment, the fine line structure is adopted in which the emitting electrode 2 and the control lines 5-1 to 5-4 function as a single emitting electrode. The inventors have confirmed whether or not the adoption of such a fine line structure causes antenna efficiency or the like to be deteriorated compared with a case in which a single emitting electrode having a normal width is used.

Specifically, using simulation, the inventors have compared a return loss and antenna efficiency at a resonant frequency in the case in which a single emitting electrode having a normal width is used with a return loss and antenna efficiency at a resonant frequency in the case in which fine lines are brought together and caused to function as a single emitting electrode as described in the present embodiment.

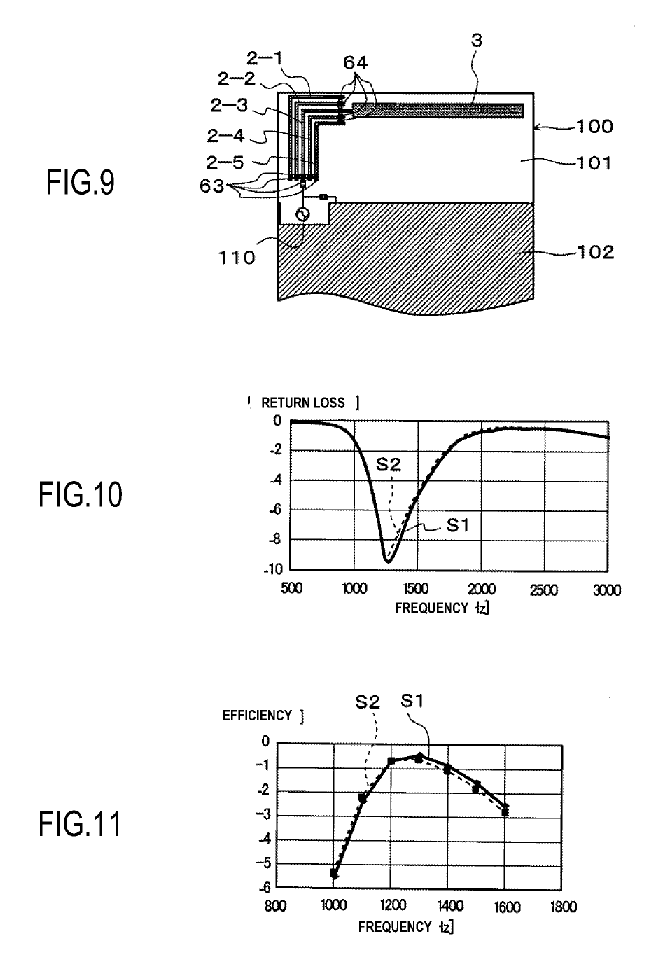

FIG. 8 is a schematic plan view illustrating an antenna device that utilizes a single emitting electrode 20, FIG. 9 is a schematic plan view illustrating an antenna device that brings fine line patterns 2-1 to 2-5 together and utilizes a portion of the antenna device as one emitting electrode, FIG. 10 is a graph showing a result of simulation of a return loss, and FIG. 11 is a graph showing a result of simulation of antenna efficiency.

First, when, in the antenna device illustrated in FIG. 8, an RF signal is supplied from a power feeding unit 110 to the emitting electrode 20, and a return loss is simulated within frequencies ranging from 500 MHz to 3 GHz, a resonant frequency located near 1250 MHz is obtained, as illustrated by a solid curved line S1 in FIG. 10.

Next, as illustrated in FIG. 9, five fine line patterns 2-1 to 2-5 are brought together, and the ends of a power feeding unit 110 side and the ends of an emitting electrode 3 side of the five fine line patterns 2-1 to 2-5 are connected to one another using capacitors 63 and 64. In addition to this, a central fine line pattern 2-3 is connected to the emitting electrode 3, and the antenna device corresponding to the present embodiment is created. In addition, in the antenna device, an RF signal is supplied from the power feeding unit 110 to the fine line pattern 2-3, and a return loss is simulated within frequencies ranging from 500 MHz to 3 GHz. Consequently, as illustrated by a dashed curved line S2 in FIG. 10, while being slightly deviated from the resonant frequency of the antenna device illustrated in FIG. 8, a resonant frequency located near 1250 MHz is obtained.

In addition, when, in the antenna devices illustrated in FIG. 8 and FIG. 9, antenna efficiency is simulated in the same way, results illustrated in FIG. 11 are obtained.

Namely, the simulation result of the antenna device in FIG. 8 becomes as illustrated by a solid curved line S1 in FIG. 11, and the simulation result of the antenna device in FIG. 9 becomes as illustrated by a dashed curved line S2 in FIG. 11. Therefore, it is confirmed that deterioration of the antenna efficiency due to the adoption of the fine line structure hardly occurs.

As described above, according to the antenna device 1 of the present embodiment, in addition to the primary emitting electrode 2, the four control lines 5-1 to 5-4 are also used as a portion of the emitting electrode, and it is possible to transmit and receive the RF signal S. Therefore, at the time of signal transmission or reception, a situation does not occur in which the emitting electrode 2 or the emitting electrode 3 is electromagnetically coupled to the control lines 5-1 to 5-4, and as a result, the occurrence of unnecessary resonance or deterioration of the antenna characteristic does not occur.

In addition, since a configuration is adopted in which four or more control lines 5-1 to 5-4 are brought together and wired in parallel with the emitting electrode 2 without being pulled along in the non-ground region 101, a large vacant space can be maintained in the non-ground region 101, and as a result, by pulling along the emitting electrode 3 within the vacant space, various emitting electrodes 3 can be formed.

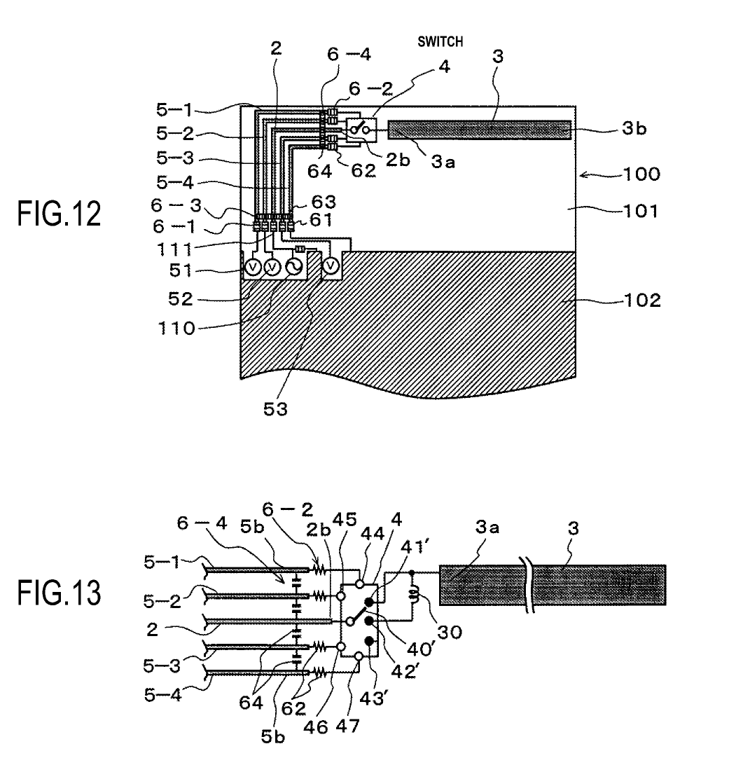

FIG. 12 is a schematic plan view illustrating an antenna device according to a second exemplary embodiment, and FIG. 13 is a pattern diagram illustrating the electric structure of a switch.

As illustrated in FIG. 12, in the antenna device according to the present embodiment, a switch 4 is applied as the integrated circuit.

The switch 4 is an element used for electrically connecting or disconnecting the emitting electrode 3 to or from the emitting electrode 2, and is provided between the other end 2b of the emitting electrode 2 and the end 3a of the emitting electrode 3.

While, as the switch 4, a semiconductor switch, a MEMS switch, a tunable capacitor, or the like may be used, the switch 4 is schematically depicted in FIG. 12 and FIG. 13.

As illustrated in FIG. 13, the switch 4 schematically includes a movable terminal 40′ and three fixed terminals 41′ to 43′. The movable terminal 40′ is connected to the other end 2b of the emitting electrode 2. In addition, the fixed terminal 41′ is directly connected to the end 3a of the emitting electrode 3, and the fixed terminal 42′ is connected to the end 3a of the emitting electrode 3 through an inductor 30 used for increasing the reactance value of the antenna. In addition, the fixed terminal 43′ is an open end.

The switch 4 includes input terminals 44 to 46 used for inputting the control signals C1 to C3 and a ground terminal 47.

The control signals C1 to C3 in the present embodiment are direct voltages and input to the input terminals 44 to 46 of the switch 4 through the control lines 5-1 to 5-3. Specifically, when the control signal C1 greater than or equal to a reference voltage is input to the input terminal 44, the movable terminal 40′ is connected to the fixed terminal 41′. When the control signal C2 greater than or equal to a reference voltage is input to the input terminal 45, the movable terminal 40′ is connected to the fixed terminal 42′. In addition, when the control signal C3 greater than or equal to a reference voltage is input to the input terminal 46, the movable terminal 40′ is connected to the fixed terminal 43′.

According to such a configuration, when the control signal C1 greater than or equal to the reference voltage and the control signals C2 and C3 less than or equal to the reference voltage are output from the control voltage sources 51 to 53 and input to the input terminals 44 to 46 of the switch 4, the movable terminal 40′ is connected to the fixed terminal 41′, and a state occurs in which the emitting electrode 2 and the emitting electrode 3 are directly connected to each other.

Accordingly, the antenna device 1 turns out to resonate with a first resonant frequency f1′ (an illustration thereof is not shown) based on the emitting electrode 2 and the emitting electrode 3.

In addition, when the control signal C3 greater than or equal to the reference voltage and the control signals C1 and C2 less than or equal to the reference voltage are input from the control voltage sources 51 to 53 to the input terminals 44 to 46 of the switch 4, the movable terminal 40′ is connected to the fixed terminal 43′ that is open, and a state occurs in which the emitting electrode 2 and the emitting electrode 3 are electrically disconnected from each other.

Accordingly, the antenna device 1 turns out to resonate with a second resonant frequency f2 based on the emitting electrode 2.

Furthermore, when the control signal C2 greater than or equal to the reference voltage and the control signals C1 and C3 less than or equal to the reference voltage are input to the input terminals 44 to 46 of the switch 4, the movable terminal 40′ is connected to the fixed terminal 42′, and a state occurs in which the emitting electrode 2 is connected to the emitting electrode 3 through the inductor 30.

Accordingly, the antenna device 1 turns out to resonate with a third resonant frequency f3 (an illustration thereof is not shown) determined on the basis of the emitting electrode 2, the emitting electrode 3, and the inductance value of the inductor 30.

Namely, in the antenna device 1, it is possible to perform transmission and reception using a multiple resonance based on the first resonant frequency f1′, the second resonant frequency f2, and the third resonant frequency f3.

Since the other configuration, a function, and an advantageous effect are the same as the first embodiment, the description of these features can be inferred from the above description.

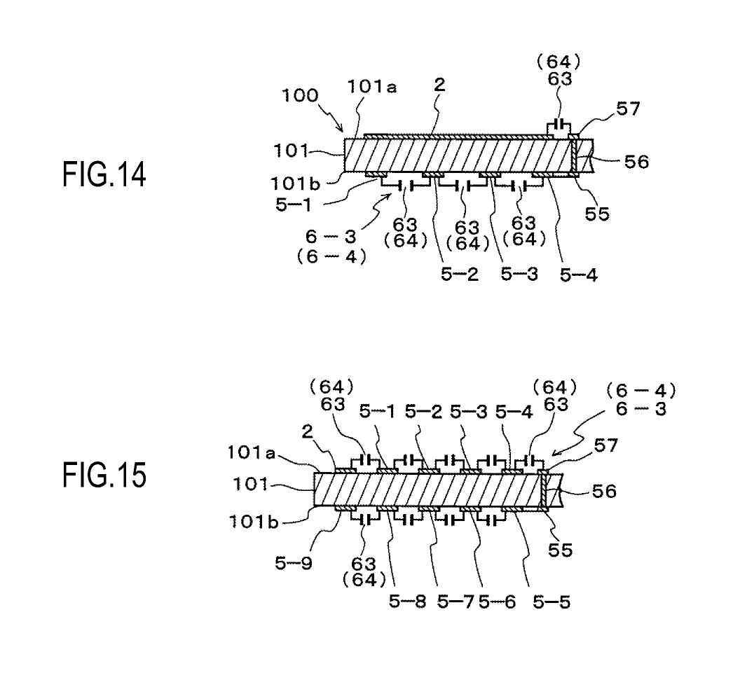

Next, a third exemplary embodiment will be described with reference to FIG. 14, which is a schematic cross-section diagram illustrating the main part of an antenna device.

The present embodiment differs from the above-mentioned first and second exemplary embodiments in that the emitting electrode 2 increases in width.

Namely, as illustrated in FIG. 14, the wide emitting electrode 2 is provided on the front surface 101a of the non-ground region 101, and four fine control lines 5-1 to 5-4 are provided on the rear surface 101b of the non-ground region 101.

In addition, the control lines 5-1 to 5-4 are connected with capacitors 63 (64) of the connection circuit 6-3 (6-4) at the ends 5a (the other ends 5b) whose illustration is not shown. Furthermore, a land 55 partially connected to the control line 5-4 is provided on the rear surface 101b, and a land 57 connected to the emitting electrode 2 through the capacitor 63 is provided on the front surface 101a. In addition, these lands 55 and 57 are connected to each other through a through-hole 56.

On the basis of such a configuration, it is possible to widen the line width of the emitting electrode 2 provided on the front surface 101a according to how much the control lines 5-1 to 5-4 are wired on the rear surface 101b of the non-ground region 101, and as a result, the conductor loss or the like of the emitting electrode 2 can be kept extremely low.

Since the other configuration, a function, and an advantageous effect are the same as the first exemplary embodiment and the second exemplary embodiment, the description of these features can be inferred from the above description.

Next, a fourth exemplary embodiment will be described with reference to FIG. 15, which is a schematic cross-section diagram illustrating the main part of an antenna device.

The present embodiment differs from the above-mentioned first to third exemplary embodiments in that a large number of control lines are provided.

Namely, as illustrated in FIG. 15, the emitting electrode 2 is provided on the front surface 101a of the non-ground region 101, and a large number of control lines 5-1 to 5-9 are wired from the front surface 101a of the non-ground region 101 to the rear surface 101b thereof.

In addition, the emitting electrode 2 and the control lines 5-1 to 5-4, located, or positioned on the front surface 101a side, are connected with the capacitors 63 (64) of the connection circuit 6-3 (6-4) at the ends 5a (the other ends 5b), and the control lines 5-5 to 5-9 located, or positioned on the rear surface 101b side are connected with the capacitors 63 (64) at the ends 5a (the other ends 5b) whose illustration is not shown. Furthermore, a land 55 partially connected to the control line 5-5 is provided on the rear surface 101b, and a land 57 connected to the control line 5-4 through the capacitor 63 is provided on the front surface 101a. In addition, these lands 55 and 57 are connected to each other through a through-hole 56.

According to such a configuration, it is possible to wire the control lines 5-1 to 5-4 without narrowing the line widths thereof more than necessary even if the number of the control lines 5-1 to 5-4 connected to the switch 4 is large.

Since the other configuration, a function, and an advantageous effect are the same as the first to the third exemplary embodiments, the description of these features can be inferred from the above description.

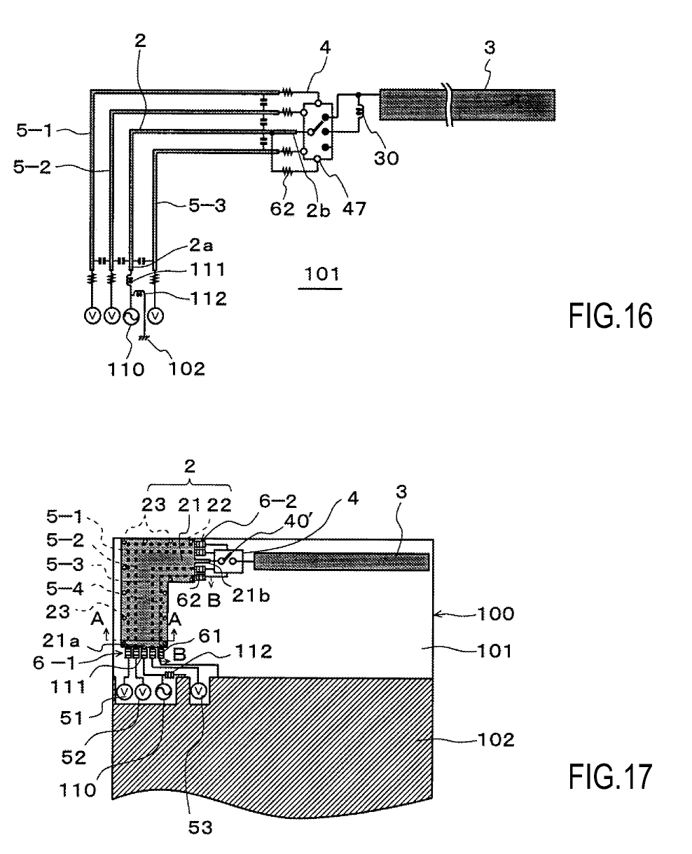

Next, a fifth exemplary embodiment will be described with reference to FIG. 16, which is a plan view specifically illustrating the electric structure of an antenna device.

The present embodiment differs from the above-mentioned first to fourth exemplary embodiments in that the number of the control lines is reduced.

Namely, as illustrated in FIG. 16, the inductor 111 that is a first inductor element is provided between the end 2a of the emitting electrode 2 and the power feeding unit 110, and the inductor 112 that is a second inductor element is provided between the end 2a and the ground region 102, thereby forming a matching circuit.

In addition, the resistor element 62 is connected from the other end 2b of the emitting electrode 2 to the ground terminal 47 of the switch 4.

According to such a configuration, since the emitting electrode 2 can double as the ground line 5-4 of the switch 4, one control line can be reduced, and hence it is possible to maintain a large vacant space in the non-ground region 101.

Since the other configuration, a function, and an advantageous effect are the same as the first to the fourth embodiments, the description of these features can be inferred from the above description.

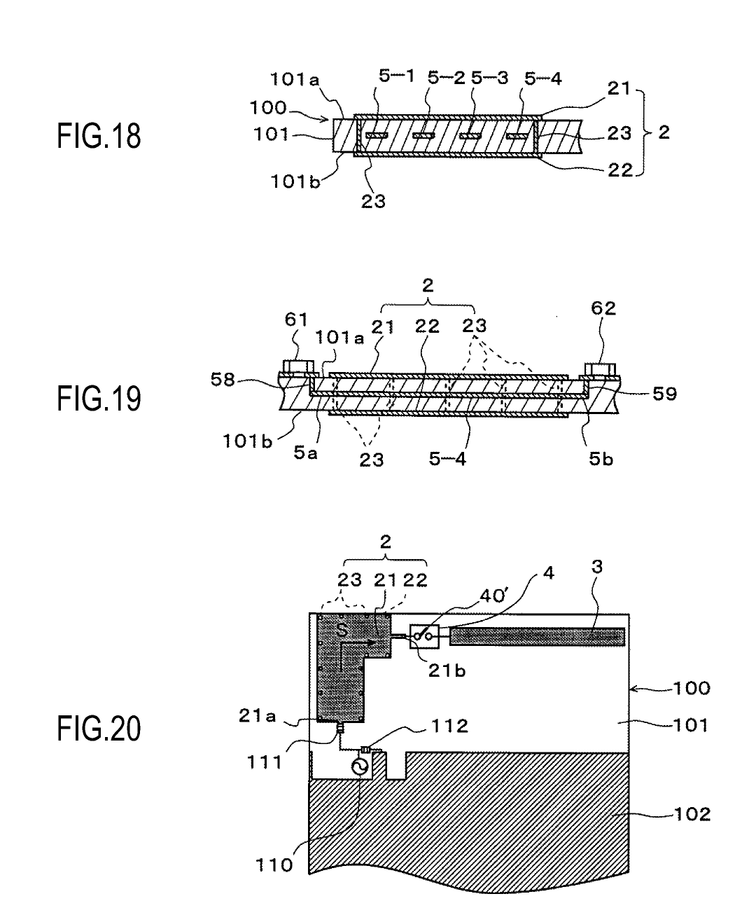

Next, a sixth exemplary embodiment will be described with reference to FIG. 17, which is a schematic plan view illustrating an antenna device, to FIG. 18, which is a cross-section diagram along an arrowed line A-A in FIG. 17, and to FIG. 19, which is a cross-section diagram along an arrowed line B-B in FIG. 17.

The present embodiment differs from the above-mentioned first to fifth exemplary embodiments in that the control lines 5-1 to 5-4 are wired within the board 100.

Namely, as illustrated in FIG. 17 to FIG. 19, the emitting electrode 2 is divided into two divided electrodes 21 and 22, and the control lines 5-1 to 5-4 are provided therebetween.

Specifically, as illustrated in FIG. 17, the divided electrode 21 is formed on the front surface 101a of the non-ground region 101 in the board 100, and the divided electrode 22 is formed on the rear surface 101b of the non-ground region 101 so as to face the divided electrode 21. In addition, as illustrated in FIG. 18 and FIG. 19, the divided electrode 21 and divided electrode 22 are electrically connected to each other at the ends thereof through a through-hole 23, and hence the emitting electrode 2 has a cage-shaped configuration in which the divided electrode 21 and the divided electrode 22 are included one above the other and a plurality of through-holes 23 are included on the side surface thereof. In addition, as illustrated in FIG. 17, one end 21a of the divided electrode 21 is connected to the power feeding unit 110 through the matching circuit including the inductors 111 and 112, and the other end 21b thereof is connected to a movable terminal 40′ of the switch 4.

In addition, in a state in which the four control lines 5-1 to 5-4 are stored within the emitting electrode 2 having a cage shape, the four control lines 5-1 to 5-4 are provided within the board 100 of the non-ground region 101. In addition, as illustrated in FIG. 19, the ends 5a of the control lines 5-1 to 5-3 and 5-4 are connected to the resistor elements 61 of the choke circuit 6-1 provided on the front surface 101a of the non-ground region 101, through a through-hole 58, and these resistor elements 61 are connected to the control voltage sources 51 to 53 and the ground region 102. Furthermore, the other ends 5b of the control lines 5-1 to 5-3 and 5-4 are connected to the resistor elements 62 of the choke circuit 6-2 provided on the front surface 101a of the non-ground region 101, through a through-hole 59, and these resistor elements 62 are connected to the input terminals 44 to 46 of the switch 4 and the ground terminal 47 (refer to FIG. 13).

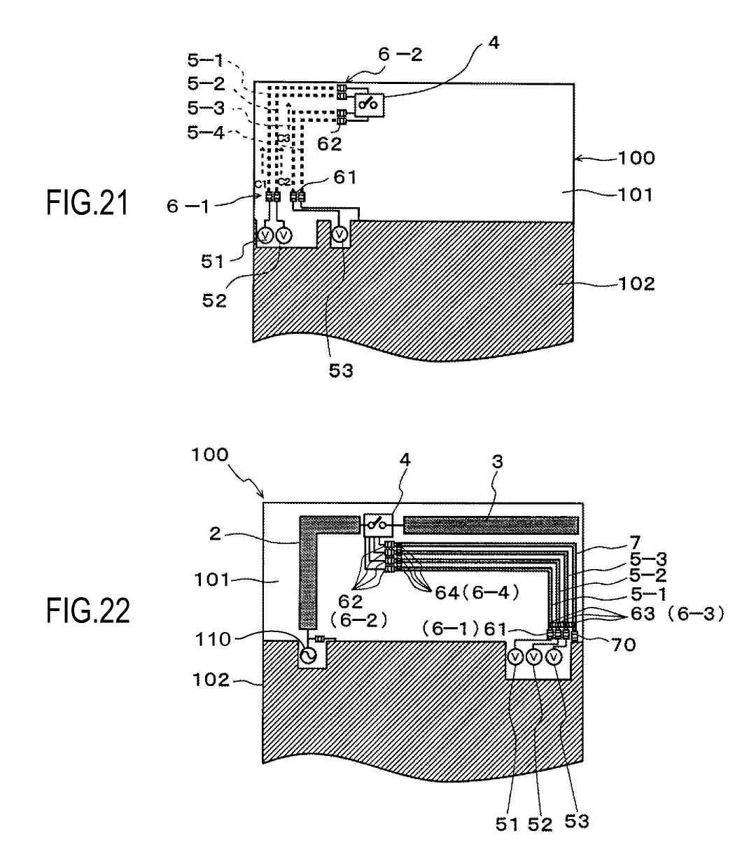

FIG. 20 is a pattern diagram illustrating a transmission or reception state of an RF signal, and FIG. 21 is a pattern diagram illustrating a transmission state of a control signal of the antenna shown in FIGS. 17-19.

When, in FIG. 17, the RF signal S is supplied from the power feeding unit 110 to the emitting electrode 2 or received, the emitting electrode 2 having a cage shape and the control lines 5-1 to 5-4 therewithin have the same potential. Therefore, when the emitting electrode 2 transmits or receives the RF signal S, the control lines 5-1 to 5-4 within the emitting electrode 2 are not electromagnetically coupled to the emitting electrode 2. Accordingly, when the RF signal S is transmitted or received, the RF signal S only flows through the cage-shaped emitting electrode 2 (21, 22, 23) as illustrated in FIG. 20, and when the control signals C1 to C3 are transmitted, each control signal C1 (C2, C3) only flows through each control line 5-1 (5-2, 5-3) within the board 100 as illustrated in FIG. 21.

As a result, the capacitors 63 and 64 (refer to FIG. 1, FIG. 2, and the like) of the connection circuits 6-3 and 6-4, used for causing the RF signal S to flow from the emitting electrode 2 to the control lines 5-1 to 5-4, are unnecessary, and hence it is possible to promote the reduction of the number of parts.

Since the other configuration, a function, and an advantageous effect are the same as the first to the fifth exemplary embodiments, the description of these features can be inferred from the above description.

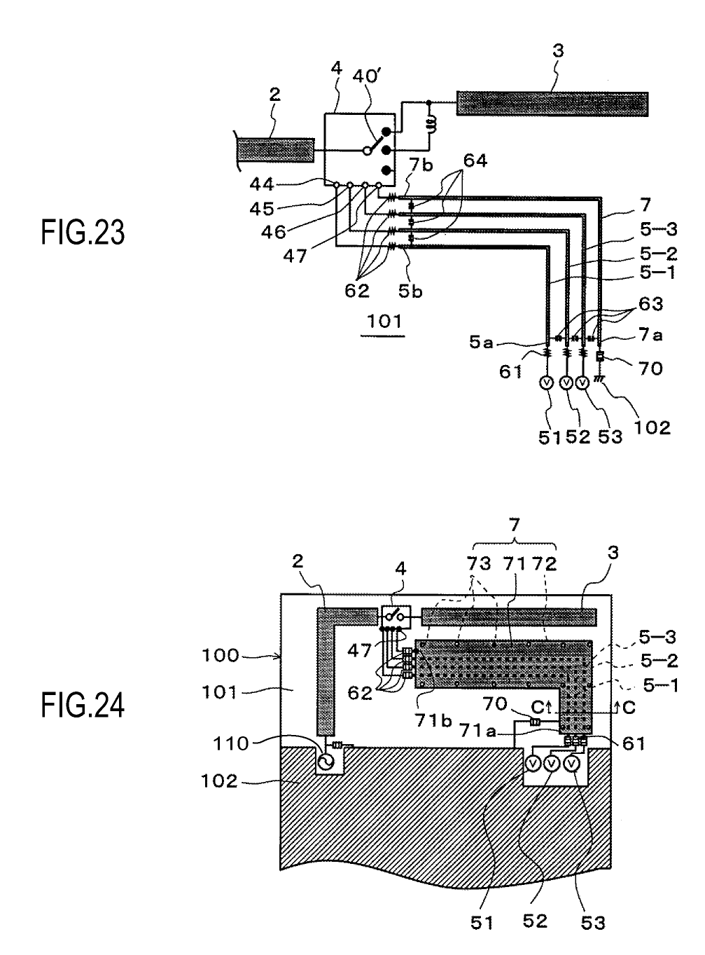

Next, a seventh exemplary embodiment will be described with reference to FIGS. 22 and 23. FIG. 22 is a schematic plan view illustrating an antenna device according to the seventh exemplary embodiment, and FIG. 23 is a plan view specifically illustrating the electric structure of the antenna device.

The present embodiment differs from the above-mentioned first to sixth exemplary embodiments in that a configuration is adopted in which an emitting electrode 7 as a third emitting electrode and three control lines 5-1 to 5-3 are caused to function as non-fed emitting electrodes.

Namely, as illustrated in FIG. 22, the emitting electrode 2 does not have a fine line pattern but has a normal width pattern whose width is the same as that of the emitting electrode 3. In addition, the three parallel control lines 5-1 to 5-3 are provided on the non-ground region 101 and located, or positioned a distance from the emitting electrodes 2 and 3, and the emitting electrode 7 is formed roughly in parallel with these control lines 5-1 to 5-3.

In addition, as illustrated in FIG. 23, the other ends 5b of the control lines 5-1 to 5-3 and the other end 7a of the emitting electrode 7 are connected to the input terminals 44 to 46 of the switch 4 and the ground terminal 47 through the resistor elements 62, and the control lines 5-1 to 5-3 are connected to the emitting electrode 7 using the capacitors 64.

In addition, the ends 5a of the control lines 5-1 to 5-3 are connected to the control voltage sources 51 to 53 through the resistor elements 61, and one end 7a of the emitting electrode 7 is grounded to the ground region 102 through a reactance element 70. In addition, the emitting electrode 7 is connected to the control lines 5-1 to 5-3 using the capacitors 63.

Namely, the emitting electrode 7 and the three control lines 5-1 to 5-3 are caused to function as one non-fed emitting electrode.

According to such a configuration, when, in FIG. 22, the RF signal S is fed from the power feeding unit 110 to the emitting electrode 2, the emitting electrode 2 or the emitting electrode 3 is electromagnetically coupled to the non-fed emitting electrode including the emitting electrode 7 and the control lines 5-1 to 5-4, and the non-fed emitting electrode 7, 5-1 to 5-3 resonates with a predetermined resonant frequency. In addition, using the switch 4, an electric connection between the emitting electrode 2 and the emitting electrode 3 is disconnected or connected, thereby also causing the amount of electromagnetic coupling to the non-fed emitting electrode 7, 5-1 to 5-3 to be changed. Therefore, it is possible to greatly change the predetermined resonant frequency.

As described above, according to the antenna device of the present embodiment, not only is it to prevent the deterioration of the antenna characteristic, but it is possible to promote having the multiple resonance characteristic and the widening of a bandwidth, on the basis of the non-fed emitting electrode including the emitting electrode 7 and the control lines 5-1 to 5-3.

Since the other configuration, a function, and an advantageous effect are the same as the first to the sixth embodiments, the description of these features can be inferred from the above description.

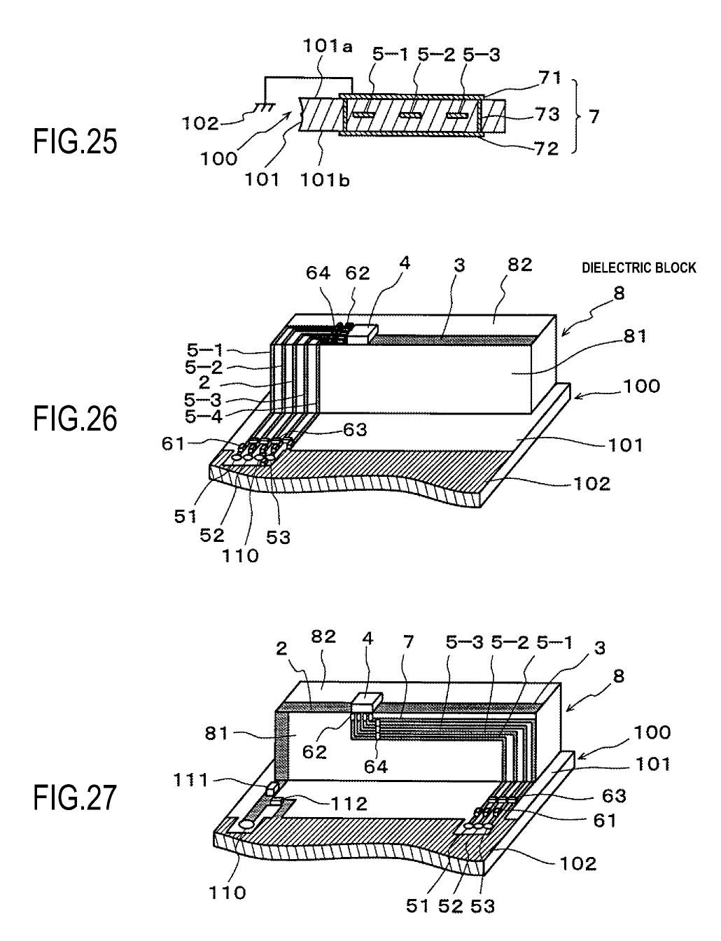

Next, an eighth exemplary embodiment will be described with reference to FIGS. 24 and 25.

FIG. 24 is a schematic plan view illustrating an antenna device according to the eighth exemplary embodiment, and FIG. 25 is a cross-section diagram along an arrowed line C-C in FIG. 24.

The present embodiment differs from the above-mentioned seventh exemplary embodiment in that the three control lines 5-1 to 5-3 are wired within the board 100.

Namely, as illustrated in FIG. 24 and FIG. 25, an emitting electrode 7 is provided and located, or positioned a distance from the emitting electrodes 2 and 3. The emitting electrode 7 is divided into two divided electrodes 71 and 72, and the control lines 5-1 to 5-3 are wired therebetween.

Specifically, the divided electrode 71 is formed on the front surface 101a of the non-ground region 101 in the board 100, and the divided electrode 72 is formed on the rear surface 101b of the non-ground region 101 so as to face the divided electrode 71. In addition, the divided electrode 71 and divided electrode 72 are electrically connected to each other at the ends thereof through a through-hole 73, and hence the emitting electrode 7 is configured in a cage-shape.

For details, as illustrated in FIG. 24, after the divided electrode 71 is caused to run so as to be adjacent to the emitting electrode 3, the divided electrode 71 is bent to the ground region 102 side, and the divided electrode 72 is formed in a shape corresponding to the divided electrode 71. In addition, one end 71a of the divided electrode 71 is grounded to the ground region 102 through the reactance element 70, and the other end 71b is connected to the ground terminal 47 of the switch 4 through the resistor element 62.

In addition, as illustrated in FIG. 25, in a state in which the three control lines 5-1 to 5-3 are stored within the emitting electrode 7 having a cage shape, the three control lines 5-1 to 5-3 are provided within the board 100 of the non-ground region 101. In addition, the ends 5a (refer to FIG. 23) of the control lines 5-1 to 5-3 are connected to the resistor elements 61 provided on the front surface 101a of the non-ground region 101, through through-holes (not illustrated), and these resistor elements 61 are connected to the control voltage sources 51 to 53. Furthermore, the other ends 5b (refer to FIG. 23) of the control lines 5-1 to 5-3 are connected to the resistor elements 62 provided on the front surface 101a of the non-ground region 101, through through-holes (not illustrated), and these resistor elements 62 are connected to the input terminals 44 to 46 of the switch 4 (refer to FIG. 23).

According to such a configuration, when, in FIG. 25, the RF signal S is fed from the power feeding unit 110 to the emitting electrode 2, the emitting electrode 7 and the control lines 5-1 to 5-3 are electromagnetically coupled to the emitting electrode 2 or the emitting electrode 3, and function as a non-fed emitting electrode. Accordingly, it is possible to promote having a multiple resonance characteristic and the widening of a bandwidth.

In addition, when the RF signal S is transmitted or received, the inside of the cage-shaped emitting electrode 7 has the same potential, and electromagnetic coupling between the control lines 5-1 to 5-4 and the emitting electrode 7 is avoided. As a result, capacitors used for splitting the flow of the RF signal S from the emitting electrode 7 into the control lines 5-1 to 5-3 become unnecessary, and hence it is possible to promote the reduction of the number of parts.

Since the other configuration, a function, and an advantageous effect are the same as the above-mentioned seventh embodiment, the description of these features can be inferred from the above description.

Next, a ninth exemplary embodiment will be described with reference to FIG. 26, which is a perspective view illustrating an antenna device.

In the present embodiment, the constituent elements of the antenna device according to the above-mentioned second exemplary embodiment are mounted on a dielectric block.

Namely, as illustrated in FIG. 26, a dielectric block 8 is provided on the non-ground region 101 of the board 100, and most of the constituent elements of the antenna device are provided on the dielectric block 8.

Specifically, the emitting electrode 2 and the four control lines 5-1 to 5-4, which have fine line patterns, are formed from the non-ground region 101 to the front side 81 and the top side 82 of the dielectric block 8, the resistor elements 61 of the choke circuit 6-1 and the capacitors 63 of the connection circuit 6-3 are attached to the ends of the control lines 5-1 to 5-4, and the resistor elements 62 of the choke circuit 6-2 and the capacitors 64 of the connection circuit 6-4 are attached to the other ends of the control lines 5-1 to 5-4. In addition, the other ends of the emitting electrode 2 and the control lines 5-1 to 5-4 are connected to the switch 4 on the top side 82. In addition, the emitting electrode 3 is formed on the top side 82, and one end thereof is connected to the switch 4.

According to such a configuration, since the emitting electrode and the control lines 5-1 to 5-4 are sterically wired using the dielectric block 8, it is possible to promote the downsizing of the antenna device.

Since the other configuration, a function, and an advantageous effect are the same as the above-mentioned second embodiment, the description of these features can be inferred from the above description.

In addition, embodiments consistent with the disclosure are not limited to the above-mentioned embodiments, and variations and modifications may occur insofar as they are within the scope of the present disclosure.

For example, while, in the above-mentioned ninth exemplary embodiment, an example has been illustrated in which the constituent elements of the second exemplary embodiment are mounted on the dielectric block 8, the constituent elements of the seventh exemplary embodiment may also be mounted on the dielectric block 8, as illustrated in FIG. 27.

Namely, as illustrated in FIG. 27, the emitting electrode 2 having a normal width is formed from the non-ground region 101 to the front side 81 and the top side 82 of the dielectric block 8 and connected to the switch 4 on the top side 82, and the emitting electrode 3 is formed on the top side 82 and connected to the switch 4.

In addition, the control lines 5-1 to 5-4 to be caused to function as non-fed emitting electrodes are formed from the front side 81 of the dielectric block 8 to the non-ground region 101, and, to the other ends thereof, the resistor elements 62 of the choke circuit 6-2 and the capacitors 64 of the connection circuit 6-4 are attached. In addition, the resistor elements 61 of the choke circuit 6-1 and the capacitors 63 of the connection circuit 6-3 are attached to the ends of the control lines 5-1 to 5-3. In addition, the end of control line 5-4 connected to the control line 5-3 through the capacitor 63 is grounded to the ground region 102.

According to such a configuration, it is possible to strengthen electromagnetic coupling between the emitting electrodes 2 and 3 and the control lines 5-1 to 5-4 that are non-fed emitting electrodes.

In addition, while, in the above-mentioned exemplary embodiments, the example has been illustrated in which the solid board 100 is applied as a board, a flexible printed board may be applied as a board, and hence it is possible to bend the board into a desired shape or strengthen electromagnetic coupling between electrodes on the upper side and the underside of the board.

In addition, while, in the above-mentioned embodiments, the resistor elements 61 and 62 have been exemplified as the constituent elements of the choke circuits 6-1 and 6-2, these are not limited to this. In addition, a circuit that allows a control signal to pass and stops an RF signal may be used as the choke circuit, and for example, inductor elements may be used as the constituent elements of the choke circuits 6-1 and 6-2. In addition, while the capacitors 63 and 64 have been exemplified as the constituent elements of the connection circuits 6-3 and 6-4, these elements are not limited to this. In addition, a circuit that causes the RF signal to be split or flow and stops the control signal may be used as the connection circuit, and various kinds of filter circuits may be used.

In addition, while, in the above-mentioned third to ninth exemplary embodiments, the switch 4 has exemplified as the integrated circuit, the integrated circuit is not limited to this. In addition, it should be understood that all circuits capable of changing a reactance value using a plurality of control lines may be applied as the integrated circuit of this disclosure.

Furthermore, while, in the above-mentioned embodiments, main parts such as the emitting electrodes 2 and 3, the integrated circuit 4, and the like of the antenna device are provided on the non-ground region 101 of the board 100, the main parts may be disposed on the ground region without being limited to this.

According to embodiments described above, a first emitting electrode and the plural control lines can function as a single emitting electrode. Accordingly, since not only does the first emitting electrode operate, but the plural control lines also operate as a portion of the emitting electrode, it is possible to prevent the occurrence of unnecessary resonance or the deterioration of the antenna characteristic due to the electromagnetic coupling of the first emitting electrode or the second emitting electrode to the control lines.

Additionally, the integrated circuit is provided between the first and the second emitting electrodes. Therefore, according to embodiments of the antenna device, a variable reactance circuit such as a switch or the like is used as the integrated circuit, and thereby it is possible to transmit and receive the RF signal using two resonant frequencies corresponding to the change of variable reactance in the same way as an example of the related art.

According to a configuration in which the first emitting electrode is disposed on a front surface side of the board and the plural control lines are disposed in parallel on a rear surface side of the board, the control lines are wired on the rear surface side of the board, and hence it is possible to widen the line width of the first emitting electrode disposed on the front surface side thereof. As a result, the conductor loss or the like of the first emitting electrode can be kept extremely low.

In a configuration in which the first emitting electrode is provided on a front surface side of the board, and the plural control lines are provided in parallel on the front surface side and a rear surface side of the board, it is possible to wire the control lines without narrowing the line widths thereof more than necessary even if the number of the control lines connected to the integrated circuit is large.

In configurations where the first emitting electrode are divided into two emitting electrodes with one of the two electrodes provided on a front surface side of the board and the other of the two electrodes provided on a rear surface side of the board, and the plural control lines provided between the two divided electrodes, at the time of the transmission or reception of the RF signal, the two divided electrodes included in the first emitting electrode and the plural control lines have the same potential, and the control lines hardly influence the emitting electrode. In addition, by having such a configuration, the first and the second connection circuits, used for causing the RF signal to flow through the first emitting electrode and the plural control lines, are unnecessary, and hence it is possible to promote the reduction of the number of parts.

Also, in a configuration having a first inductor element provided between the one end of a first emitting electrode and the power feeding unit and a second inductor element provided between the one end and a ground, to thereby form a matching circuit, and having a resistor element or an inductor element connected from the other end of the first emitting electrode to a ground terminal of the integrated circuit, the first emitting electrode can double as the ground line of the integrated circuit.

In embodiments in which a dielectric block is provided on the board, and all of or part of the first and the second emitting electrodes, the integrated circuit, the plural control lines, and the first and the second connection circuits is provided on the dielectric block, since the emitting electrode and the control lines are sterically wired using the dielectric block, it is possible to promote the downsizing of the antenna device.

Additionally, in embodiments using a flexible printed board as the board, since the flexible printed board can be thin-filmed, it is possible to strengthen electromagnetic coupling between electrodes on the front surface side and the rear surface side of the board, which is especially effective when a non-fed emitting electrode is disposed on the rear surface side of the board. Furthermore, it is possible to bend such a board into a desired shape.

According to an embodiment in which the integrated circuit is a switch for electrically connecting or disconnecting the first emitting electrode and the end of the second emitting electrode to or from each other, the control unit is adapted to supply the low frequency control signal to control the switch, in a state in which the first ends of the plural control lines are connected to a control unit, and the plural control lines are on the board and the second ends thereof are connected to the switch, when the control signal is sent from the control unit to the switch through the plural control lines, and the switch causes the first emitting electrode and the second emitting electrode to be put into a state in which the first emitting electrode and the second emitting electrode are electrically connected to each other, resonance with a first resonant frequency based on the first emitting electrode and the second emitting electrode occurs.

In addition, on the basis of the control signal from the control unit, the switch puts the first emitting electrode and the second emitting electrode into a state in which the first emitting electrode and the second emitting electrode are electrically disconnected from each other, resonance with a second resonant frequency corresponding to the first emitting electrode occurs.

In an antenna device and board including configuration having a third emitting electrode, as described above, when the RF signal is fed, the third emitting electrode and the plural control lines are electromagnetically coupled to the first and the second emitting electrodes, and function as non-fed emitting electrodes. Accordingly, the third emitting electrode and the plural control lines can be used as non-fed emitting electrodes in this way, and hence it is possible to promote having a multiple resonance characteristic and the widening of a bandwidth.

According to a configuration in which a third emitting electrode is positioned a distance from the first and the second emitting electrodes, and is divided into two emitting electrodes with one of the two electrodes provided on a front surface side of the board and the other of the two electrodes provided on a rear surface side of the board, and the plural control lines are between the two divided electrodes, when the RF signal is fed, the two divided electrodes, included in the third emitting electrode, and the plural control lines are electromagnetically coupled to the first and the second emitting electrodes, and function as non-fed emitting electrodes. Accordingly, the third emitting electrode and the plural control lines are used as non-fed emitting electrodes in this way, and hence it is possible to promote having a multiple resonance characteristic and the widening of a bandwidth.

In addition, at the time of resonance, the third emitting electrode and the plural control lines have the same potential. Therefore, the first and the second connection circuits, used for causing the RF signal to flow through the third emitting electrode and the plural control lines, are unnecessary, and hence it is possible to promote the reduction of the number of parts.

As described above in detail, according to the antenna device according to exemplary embodiment, since, in addition to the primary emitting electrode, the plural control lines are also used, and it is possible to transmit and receive the RF signal using the first emitting electrode or the third emitting electrode and the plural control lines as a single emitting electrode. Therefore, the antenna device has an advantageous effect that, at the time of the transmission or reception of the RF signal, it is possible to prevent the occurrence of unnecessary resonance or the deterioration of the antenna characteristic due to the electromagnetic coupling of the first emitting electrode or the second emitting electrode to the control lines. In addition, since it is possible to minimize a space used for pulling along the plural control lines, a large vacant space used for forming the emitting electrode can be maintained. Furthermore, since the first emitting electrode or the third emitting electrode and the plural control lines are caused to function as a single emitting electrode, the antenna device has an advantageous effect that it is possible to widen the apparent electrode width of the first emitting electrode or the third emitting electrode.

According to embodiments described above utilizing a third emitting electrode, it is possible to effectively use, as a non-fed emitting electrode, the third emitting electrode connected to the ground, along with the plural control lines, and as a result, it is possible to promote having a multiple resonance characteristic and the widening of a bandwidth.

In addition, it is possible to wire the control lines without narrowing the line widths thereof more than necessary even if the number of the control lines connected to the integrated circuit is large, and as a result, it is possible to wire a necessary number of control lines on the board without causing the deterioration of the antenna characteristic to occur.

In addition, since the first emitting electrode can double as the ground line of the integrated circuit, the number of the control lines can be reduced, and hence it is possible to maintain a large vacant space on the board.

Furthermore, it is possible to promote the reduction of the number of parts, and hence it is possible to promote the reduction of a manufacturing cost.

Furthermore, not only is it possible to promote the reduction of a manufacturing cost on the basis of the reduction of the number of parts, but it is also possible to promote having a multiple resonance characteristic and the widening of a bandwidth.

In addition, since the first emitting electrode can double as the ground line of the integrated circuit, a dedicated ground line is unnecessary.

In addition, it is possible to promote the downsizing of the antenna device.

In addition, with disclosed embodiments it is possible to strengthen electromagnetic coupling between electrodes on the front surface side and the rear surface side of the board, which is especially effective when the non-fed emitting electrode is disposed on the rear surface side of the board. Furthermore, since it is possible to bend the board into a desired shape, it is possible to promote the downsizing of the antenna device.

According to a disclose embodiment of a wireless communication device, it is possible to prevent the deterioration of an antenna characteristic, and perform high-performance transmission and reception.

While exemplary embodiments have been described above, it is to be understood that variations and modifications will be apparent to those skilled in the art without departing from the scope and spirit of the disclosure.

What is claimed is:

1. An antenna device and board, comprising:
a first emitting electrode having one end connected to a power feeding unit adapted to supply a high-frequency RF signal;
a second emitting electrode having one end near an other end of the first emitting electrode, the second emitting electrode having at least one leading end that is open;
an integrated circuit between an other end of the first emitting electrode and the one end of the second emitting electrode;
plural control lines having respective first ends connected to a control unit adapted to supply a low-frequency control signal for controlling the integrated circuit, and having respective second ends connected to the integrated circuit;
a first connection circuit adapted to connect the plural control lines and the first emitting electrode with a high frequency signal is provided between the first ends of the plural control lines and the one end of the first emitting electrode; and
a second connection circuit between the second ends of the plural control lines and the other end of the first emitting electrode, said second connection circuit adapted to connect the plural control lines and the first emitting electrode with a high frequency signal, wherein
the plural control lines are wired along the first emitting electrode, and said first and second connection circuits cause the RF signal to flow through the first emitting electrode and the plural control lines.

2. The antenna device and board according to claim 1, wherein
the first emitting electrode is provided on a front surface side of the board, and
the plural control lines are provided in parallel on a rear surface side of the board.

3. The antenna device and board according to claim 1, wherein
the first emitting electrode is provided on a front surface side of the board, and
the plural control lines are provided in parallel on the front surface side and a rear surface side of the board.

4. An antenna device and board according to claim 1, wherein
the first emitting electrode is divided into two emitting electrodes with one of the two electrodes provided on a front surface side of the board and the other of the two electrodes provided on a rear surface side of the board, and
the plural control lines are provided between the two divided electrodes.

5. An antenna device and board according to claim 4, further comprising at least one conductive through hole formed through the board electrically connecting the two divided electrodes.

6. The antenna device and board according to claim 1, further comprising:
a first inductor element between the one end of the first emitting electrode and the power feeding unit, and a second inductor element between the one end and ground, thereby forming a matching circuit; and
a resistor element or an inductor element connected from the other end of the first emitting electrode to a ground terminal of the integrated circuit.

7. The antenna device and board according to claim 1, further comprising:
a dielectric block on the board, wherein
all or part of the first and the second emitting electrodes, the integrated circuit, the plural control lines, and the first and the second connection circuits is provided on the dielectric block.

8. The antenna device and board according claim 1, wherein the board is a flexible printed board.

9. The antenna device and board according claim 1, wherein
the integrated circuit is a switch for electrically connecting or disconnecting the first emitting electrode and the second emitting electrode to or from each other,
the control unit is adapted to supply the low frequency control signal to control the switch, and
in a state in which the first ends of the plural control lines are connected to the control unit, the plural control lines are on the board and the second ends thereof are connected to the switch.

10. The antenna device and board according to claim 1, wherein
the first connection circuit includes capacitors connected between the first ends of the plural control lines and the one end of the first emitting electrode and are low impedance to the RF signal and high impedance to the control signal, and
the second connection circuit includes other capacitors connected between the second ends of the plural control lines and the other end of the first emitting electrode and are low impedance to the RF signal and high impedance to the control signal.

11. The antenna device according to claim 1, further comprising:
a first choke circuit between the first ends of the plural control lines and the control unit, said first choke circuit adapted to allow the control signal to pass and stop the RF signal; and
a second choke circuit between the second ends of the plural control lines and the integrated circuit, said second choke circuit adapted to allow the control signal to pass and stop the RF signal.

12. A wireless communication device comprising the antenna device described in claim 1.

13. An antenna device and board, comprising:
a first emitting electrode having one end connected to a power feeding unit adapted to supply a high-frequency RF signal;
a second emitting electrode having one end near an other end of the first emitting electrode, the second emitting electrode having at least one leading end that is open;
an integrated circuit between an other end of the first emitting electrode and the one end of the second emitting electrode;
plural control lines having respective first ends connected to a control unit adapted to supply a low-frequency control signal for controlling the integrated circuit, and having respective second ends connected to the integrated circuit;
a third emitting electrode having one end connected to a ground through a reactance element;
a first connection circuit between the first ends of the plural control lines and the one end of the third emitting electrode, said first connection circuit adapted to connect the plural control lines and the third emitting electrode with a high frequency signal; and
a second connection circuit between the second ends of the plural control lines and an other end of the third emitting electrode, said second connection circuit adapted to connect the plural control lines and the third emitting electrode with a high frequency signal, wherein
the plural control lines are roughly parallel and positioned a distance from the first and the second emitting electrodes, and the third emitting electrode is roughly parallel with the plural control lines.

14. The antenna device and board of claim 13, wherein
the third emitting electrode is positioned a distance from the first and the second emitting electrodes, and is divided into two emitting electrodes with one of the two electrodes provided on a front surface side of the board and the other of the two electrodes provided on a rear surface side of the board, and
the plural control lines are between the two divided electrodes.

15. An antenna device and board according to claim 14, further comprising at least one conductive through hole formed through the board electrically connecting the divided third emitting electrode.

16. The antenna device according to claim 13, wherein
the first connection circuit includes capacitors connected between the first ends of the plural control lines and the end of the third emitting electrode, and are low impedance to the RF signal and high impedance to the control signal, and
the second connection circuit includes other capacitors connected between the second ends of the plural control lines and the other end of the third emitting electrode, and are low impedance to the RF signal and high impedance to the control signal.

17. The antenna device and board according to claim 13, further comprising:
a dielectric block on the board, wherein
all or part of the first to third emitting electrodes, the integrated circuit, the plural control lines, and the first and the second connection circuits is provided on the dielectric block.

18. The antenna device and board according claim 13, wherein the board is a flexible printed board.

19. The antenna device according to claim 13, further comprising:
a first choke circuit between the first ends of the plural control lines and the control unit, said first choke circuit adapted to allow the control signal to pass and stop the RF signal; and
a second choke circuit between the second ends of the plural control lines and the integrated circuit, said second choke circuit adapted to allow the control signal to pass and stop the RF signal.

20. A wireless communication device comprising the antenna device described in claim 13.
